(19) United States
(12) Patent Application Publication
(10) Pub. No.: US 2025/0001926 A1
(43) Pub. Date: Jan. 2, 2025

(54) HOOK HELPER DEVICE AND METHOD OF USE

(71) Applicant: Amos Outdoor Products LLC, Marinette, WI (US)

(72) Inventor: Keith John Roubal, Marinette, WI (US)

(73) Assignee: Amos Outdoor Products LLC, Marinette, WI (US)

(21) Appl. No.: 18/758,148

(22) Filed: Jun. 28, 2024

Related U.S. Application Data
(60) Provisional application No. 63/628,169, filed on Jun. 29, 2023.

(51) Int. Cl. B60P 7/08

(52) U.S. Cl. CPC B60P 7/0853

(57) ABSTRACT

The hook helper device includes a securing body, with a securing loop extending outwardly from a first end of the securing body. At least one magnet is located within the securing body to contact a ferromagnetic surface and hold the hook helper device in place, along with the connected hook. Connecting the hook helper device to a hook is a matter of passing the securing loop through a closed loop on the hook until at least a length of the securing loop longer than a circumference of a securing body extends through the closed loop, then moving the second end of the securing body and the securing body itself through the securing loop until the securing loop extends around the hook. The hook helper device can be left in place during other operations or removed.

### CROSS-REFERENCE TO RELATED APPLICATIONS

This application claims the benefit of prior-filed, co-pending U.S. Provisional Patent Application No. 63/628,169, filed on Jun. 29, 2023, the contents of which are incorporated herein by reference in their entirety.

### BACKGROUND

This invention relates to a hook attachment system, specifically a magnetic hook holder.

Trailers and other cargo transport vehicles often require additional means for securing their cargo in place during transport. One such means is a strap connected at one end to an attachment hook and at the other end to a tightening device, often a ratcheting device. The attachment hook is removably affixed to a first anchor point of the transport vehicle, typically on a first side of the transport vehicle. The tightening device is attached to a second anchor point, typically on a second side of the transport vehicle opposite the first. In certain systems, the second anchor point may be on the cargo itself. The tightening device is then actuated to shorten the strap, drawing the strap tight against the cargo or between the first and second anchor points, and keeping the cargo in place during movement of the transport vehicle. Various other securing systems use chains or other flexible lines attached to the attachment hook in place of the strap and may include other tightening devices. In certain systems, the tightening device is located on a line between two attachment hooks, or connecting two lines between two attachment hooks. In such systems, the first and second attachment hooks are attached to the first and second anchor points, respectively.

Difficulties arise during the tightening phase, when the attachment hook may not be visible to a user. If the attachment hook detaches from its anchor point without the user being aware, the user may waste time tightening a line that is no longer connected at two points, requiring them to start the process all over again. Worse, the now-free attachment hook may catch on part of the cargo or transport vehicle not intended, causing damage to the cargo or transport vehicle, or dislodgement of the cargo as the line is tightened. During movement of the transport vehicle, the attachment hook may become dislodged, resulting in unsecured cargo movement that may damage the cargo or transport vehicle. Transport vehicles without any cargo may need to secure untightened lines to prevent them from entangling or falling off the transport vehicle during movement.

There is an unmet need in the art for a device that can keep an attachment hook in place without interfering with the connection between the attachment hook and anchor point.

### BRIEF SUMMARY OF THE INVENTION

The hook helper device includes a securing body, with a securing loop extending outwardly from a first end of the securing body. At least one magnet is located within the securing body between a first end and a second end of the securing body.

A method for using such a hook helper device includes passing the securing loop through a closed loop on or connected to the attachment hook until at least a length of the securing loop longer than a circumference of a securing body extends through the closed loop. The second end of the securing body is then moved around the attachment hook toward the securing loop until the attachment hook is located between the securing body and the securing loop. The second end of the securing body is passed through the securing loop, with the securing body also advancing through the securing loop until the securing loop extends around the attachment hook. A ferromagnetic attachment surface is contacted with a portion of the securing body which includes at least one magnet.

### BRIEF DESCRIPTION OF THE DRAWINGS

FIG. 1a shows a front view of an exemplary embodiment of a ratchet hook helper system.

FIG. 1b shows a side view of the exemplary embodiment of the system.

FIG. 2 shows a flowchart of an exemplary embodiment of a method for using the ratchet hook helper system.

### DETAILED DESCRIPTION OF THE INVENTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

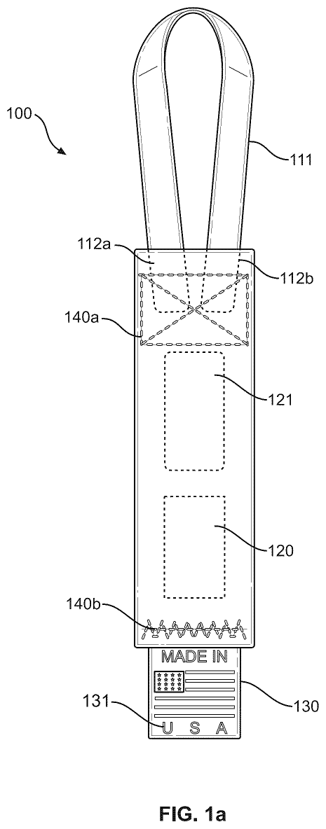

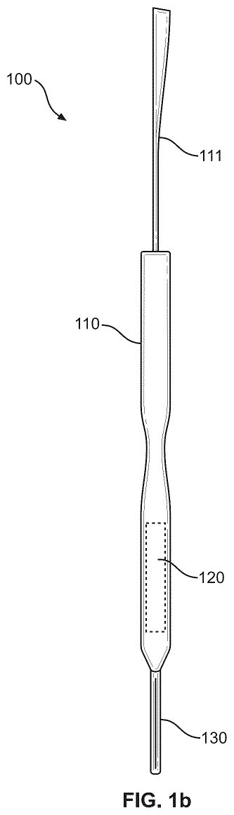

As shown in FIGS. 1a and 1b, the hook helper device 100 includes a securing body 110. Extending from a first end of the securing body 110 is a securing loop 111. Loop ends 112a and 112b of the securing loop 111 extend into the securing body 110, connecting the securing loop thereto. Extending from a second end of the securing body 110 opposite the first end is at least one optional indicia tag 130. At least one magnet 120 is located within the securing body 110 between the securing loop 111 and indicia tag 130. In certain embodiments, at least one optional spacer 121 is also located within the securing body 110 between the magnet 120 and one of the securing loop 111 or the indicia tag 130. The magnet 120 is held within the securing body 110 by means of stitching 140a and 140b at opposite ends of the securing body 110. The stitching 140a also secures the loop ends 112a and 112b of the securing loop 111 into the securing body. The stitching 140b also secures the indicia tag 130 in place.

The securing body 110 is a flexible hollow element to accommodate insertion of the loop ends 112a and 112b, indicia tag 130, and magnet 120. In certain embodiments, the securing body 110 is made up of a segment of a material shaped as a hollow tube. In certain embodiments, the securing body 110 is made up of an envelope created by folding over a segment of material and stitching, adhering, sealing, or otherwise connecting one edge of the segment with another edge of the segment. In certain embodiments, the securing body 110 is made up of an envelope created by overlapping a first segment of material with a second segment of material. At least two edges of the first segment are stitched, adhered, sealed, or otherwise connected with at least two edges of the second segment. In certain embodiments, the material is a woven or nonwoven fabric. In certain embodiments, the material is a woven polymer webbing. In certain embodiments, the securing body 110 has a length of approximately two to four inches. In certain embodiments, the securing body 110 has a width of approximately one to two inches. In the embodiment of FIGS. 1a and 1b, the securing body 110 is a tubular length of woven polymer webbing.

The securing loop 111 is a flexible U-shaped loop with the loop ends 112a and 112b extending into the securing body 110 such that the curved portion of the securing loop 111 extends outwardly from the first end of the securing body 110. In certain embodiments, the securing loop 111 is made up of a woven polymer webbing. In certain embodiments, the securing loop 111 is made up of a flat woven material. In certain embodiments, the securing loop 111 has a length greater than or equal to the length of the securing body 110. In any event, the material making up the securing loop 111 has a length greater than the circumference of the securing body 110 to allow the loop to extend around a portion of the attachment hook and still have sufficient clearance to pass the length of the securing body 110 through the securing loop 111 when attaching the hook helper device 100 to the attachment hook. In certain embodiments, the securing loop 111 has a length of approximately two to four inches.

The at least one magnet 120 is at least one permanent magnet. The at least one magnet 120 has a magnetic strength sufficient to hold the helper device 100 and the attachment hook in place when the portion of the securing body 110 which encloses the at least one magnet 120 contacts a ferromagnetic attachment surface on the transport vehicle or cargo. In certain embodiments, the magnet 120 has a pull strength of up to 30 pounds. The magnet 120 is sized to fit within the securing body 110. The magnet 120 has at least one planar surface extending along the longitudinal axis of the securing body 110 to ensure secure magnetic attachment with a ferromagnetic attachment surface through the material of the securing body 110. In certain embodiments, the magnet 120 has at least two opposing planar surfaces extending along a longitudinal axis of the securing body 110. In certain embodiments, the magnet 120 has a substantially rectangular cuboid configuration, with the two largest planar surfaces of the magnet 120 extending along a longitudinal axis of the securing body 110. In certain embodiments, the magnet 120 may be a magnetic assembly of two or more magnets 120 extending in a serial and/or parallel configuration along a longitudinal axis of the securing body 110. In such an embodiment, the combined pull strength of the magnetic assembly is up to 30 pounds.

In certain embodiments, the spacer 121 may be used to ensure correct position and/or orientation of the magnet 120 within the securing body 110. The spacer 121 is at least one mass of material. The mass may be unitary, a plurality of discrete masses, or a volume of particles. Certain embodiments may include two or more spacers 121.

In various embodiments, the indicia 131 located on the at least one optional indicia tag 130 may identify the country of manufacture, identify and/or provide contact information for the manufacturer and/or seller, and/or include at least one legal notice for the hook helper device 100. In certain embodiments, the indicia 131 located on the indicia tag 130 may include instructions for using the hook helper device 100. Such indicia 131 may be printed on, stitched into, or woven into the indicia tag 130. Certain embodiments may include more than one indicia tag 130.

The stitching 140a and 140b both closes the securing body 120 to prevent loss of the magnet 120 and strongly connects the securing loop 111 and indicia tag 130 to the securing body 120. In the embodiment shown in FIG. 1a, the stitching 140a is a box X stitch and the stitching 140b is a bar tack stitch. Other embodiments may use other stitches depending on the material used for the securing body 110 and securing loop 111. In certain embodiments, the stitching 140a and 140b is any other means of closing the securing body 120 and connecting the securing loop 111, such as, but not limited to, adhesives, welding, bonding, and any combination thereof.

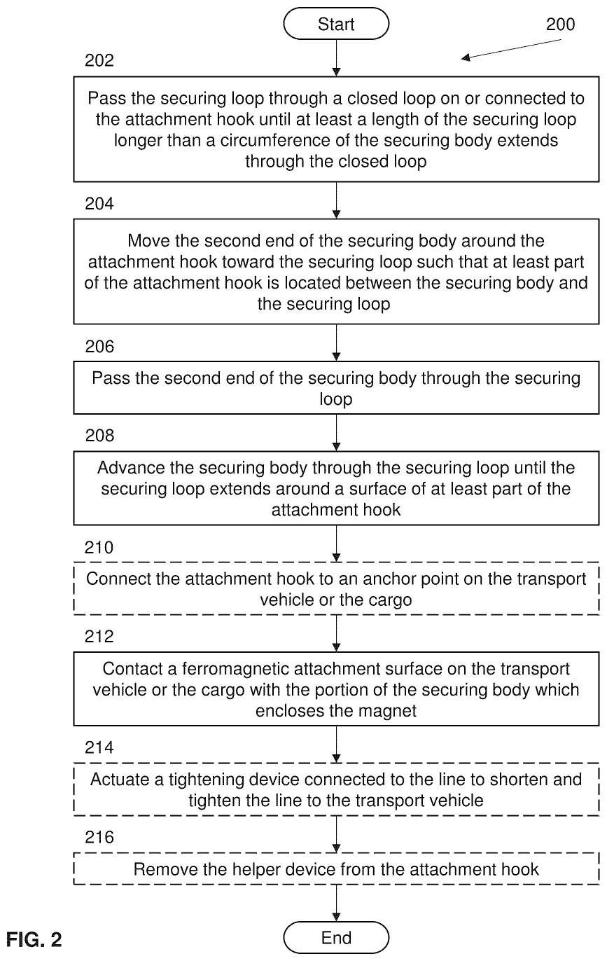

FIG. 2 is a flowchart of an exemplary embodiment of a method 200 for using the hook helper device 100 with an attachment hook. In certain embodiments, the helper device 100 itself secures the attachment hook to the transport vehicle. In other embodiments, the helper device 100 is used during a process for attaching the attachment hook to the transport vehicle and tightening a strap or other line connected to the attachment hook. It should be understood that not all of the blocks listed below need to be performed when performing the method 200. It should be understood that not all of the blocks need to be performed in the exact order shown below.

In block 202, the method 200 passes the securing loop 111 through a closed loop on or connected to the attachment hook until at least a length of the securing loop 111 longer than a circumference of the securing body 110 extends through the closed loop. In certain embodiment the closed loop may be a partially- or temporarily-closed loop.

In block 204, the method 200 moves the second end of the securing body 110 around the attachment hook toward the securing loop 111 until at least part of the attachment hook is located between the securing body 110 and the securing loop 111. In certain embodiments, the second end of the securing body 110 is connected to the indicia tag 130.

In block 206, the method 200 passes the second end of the securing body 110 through the securing loop 111. This will encircle at least part of the attachment hook with the helper device 100.

In block 208, the method 200 advances the securing body 110 through the securing loop 111 until the securing loop 111 extends around a surface of at least part of the attachment hook.

In optional block 210, the method 200 connects the attachment hook to an anchor point on the transport vehicle or the cargo.

In block 212, the method 200 contacts the ferromagnetic attachment surface on the transport vehicle or the cargo with the portion of the securing body 110 which encloses the magnet 120.

In optional block 214, the method 200 actuates a tightening device connected to the line to shorten and tighten the line to the transport vehicle.

In optional block 216, the method 200 removes the helper device 100 from the attachment hook by removing the securing body 110 from the ferromagnetic attachment surface, reversing the movement made in block 208 until the securing loop 111 no longer extends around the attachment hook and reversing the movement made in block 202 until the securing loop 111 no longer extends through the closed loop.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and/or method steps described herein may be used alone or in combination with other configurations, systems and/or method steps. It is to be expected that various equivalents, alternatives and/or modifications are possible within the scope of the appended claims.

What is claimed is:

1. A hook helper device, comprising:
a securing body;
a securing loop extending outwardly from a first end of the securing body; and
at least one magnet within the securing body between a first end of the securing body and a second end of the securing body.

2. The device of claim 1, wherein the securing body comprises a segment of a hollow tube.

3. The device of claim 1, wherein the securing body comprises an envelope of at least one segment of material.

4. The device of claim 1, wherein the securing body comprises a woven or nonwoven fabric.

5. The device of claim 1, wherein the securing body comprises a woven polymer webbing.

6. The device of claim 1, wherein the securing loop comprises a flat woven material.

7. The device of claim 1, wherein the securing loop comprises a woven polymer webbing.

8. The device of claim 1, wherein the at least one magnet comprises at least one permanent magnet.

9. The device of claim 1, wherein the at least one magnet has a pull strength of up to 30 pounds.

10. The device of claim 1, wherein the at least one magnet comprises at least one planar surface extending along the longitudinal axis of the securing body.

11. The device of claim 1, wherein the at least one magnet comprises at least two opposing planar surfaces extending along a longitudinal axis of the securing body.

12. The device of claim 1, wherein the at least one magnet comprises a substantially rectangular cuboid configuration.

13. The device of claim 1, wherein the at least one magnet comprises a magnetic assembly of two or more magnets extending in a serial, parallel, or combined serial and parallel configuration along a longitudinal axis of the securing body.

14. The device of claim 1, further comprising at least one indicia tag extending outwardly from the second end of the securing body.

15. The device of claim 14, wherein the at least one indicia tag further comprises indicia selected from the group consisting of: identification of the country of manufacture, identification of a manufacturer, identification of a seller, contact information for the manufacturer, contact information for the seller, at least one legal notice, and instructions for using the device.

16. The device of claim 1, further comprising at least one spacer located between the at least one magnet and the first end of the securing body or between the at least one magnet and the second end of the securing body.

17. A method for using a hook helper device, comprising:
passing a securing loop through a closed loop on or connected to the attachment hook until at least a length of the securing loop longer than a circumference of a securing body extends through the closed loop, wherein the securing loop extends outwardly from the first end of the securing body;
moving a second end of the securing body around the attachment hook toward the securing loop until the attachment hook is located between the securing body and the securing loop;
passing the second end of the securing body through the securing loop;
advancing the securing body through the securing loop until the securing loop extends around the attachment hook;
contacting a ferromagnetic attachment surface with a portion of the securing body which includes at least one magnet.

18. The method of claim 17, further comprising connecting the attachment hook to an anchor point on a transport vehicle.

19. The method of claim 18, further comprising actuating a tightening device connected to a line connected to the attachment hook.

20. The method of claim 18, further comprising removing the hook helper device from the attachment hook.
